(19) United States
(12) Patent Application Publication
(10) Pub. No.: US 2012/0256738 A1
(43) Pub. Date: Oct. 11, 2012

(54) Display Device, Terminal Device, and Display-Device Connection Support System

(75) Inventor: Tsuyoshi Egawa, Osaka (JP)

(73) Assignee: PANASONIC CORPORATION, Osaka (JP)

(21) Appl. No.: 13/440,996

(22) Filed: Apr. 6, 2012

(30) Foreign Application Priority Data
Apr. 6, 2011 (JP) 2011-084265
Mar. 22, 2012 (JP) 2012-065244

(51) Int. Cl. G08B 9/00

(52) U.S. Cl. 340/286.02

(57) ABSTRACT

A display device 100 determines visual identification information for visually distinguishing the display device 100 from other display devices in a terminal device 200, on the basis of unique information for the display device 100, and displays the visual identification information. The display device 100 transmits shared identification information to the terminal device 200 as information from which the terminal device 200 can obtain the visual identification information determined by the display device 100. Before a connection to the terminal device 200 is established, the display device 100 displays the visual identification information and transmits the shared identification information to the terminal device 200.

### BACKGROUND OF THE INVENTION

1. Field of the Invention

The present invention relates to display devices, such as monitors or projectors, that are connected to a network in common with terminal devices such as personal computers (PCs) and display terminal-device screens, and particularly relates to a display device that enables reliable connection to a terminal device.

2. Description of the Background Art

Recent display devices such as monitors and projectors have functionality to receive display information via a network such as a wired LAN or wireless LAN.

As a method for identifying these display devices in a terminal device such as a PC, there is a method using identification information such as a MAC address, or the service set identifier (SSID) of the display device. In the conventional method, prior to transmission of a display image from a terminal device to a projector, the MAC addresses of projectors that can perform communication with the terminal device are displayed on the terminal device. Then, when a user looks at the MAC addresses and selects a projector, visual information indicating start of communication is displayed on a display screen of the selected projector, and transmission of the display image from the terminal device is started.

### SUMMARY OF THE INVENTION

The present invention provides a display device that is connected to a network, receives image data transmitted from a terminal device, and displays received images generated from the image data. The display device includes: a visual information determination section for determining visual identification information for visually distinguishing, in the terminal device, the display device from other display devices, on the basis of preset unique information that is unique to the display device; a display section for displaying the visual identification information determined by the visual information determination section; and a communication section for transmitting shared identification information to the terminal device as information from which the terminal device can obtain the visual identification information determined by the visual information determination section. Before a connection to the terminal device is established, the display section displays the visual identification information and the communication section transmits the shared identification information to the terminal device.

Further, the shared identification information may include at least either one of the unique information and information regarding a mode of the visual identification information.

Further, the visual information determination section may perform a checking operation of checking visual identification information for another display device with which the display device can communicate, and may determine the visual identification information for the display device on the basis of the visual identification information for another display device having been identified through the checking operation. In such a case, the visual information determination section may determine the visual identification information for the display device such that the visual identification information for the display device does not overlap the visual identification information for another display device having been identified through the checking operation. In addition, the visual information determination section may determine the visual identification information for the display device such that the visual identification information for the display device does not belong to a predetermined range of similarity to the visual identification information for another display device having been identified through the checking operation. Further, in the checking operation, the visual information determination section may obtain, from another display device with which the display device can communicate, information including at least either one of information corresponding to the unique information and information regarding a mode of the visual identification information for the other display device, and may identify the visual identification information for the other display device from the obtained information. Moreover, the visual information determination section may be configured to be enabled to perform: a normal determination operation of determining the visual identification information on the basis of the unique information; and a provisional determination operation of determining the visual identification information by a method different from that of the normal determination operation when it is determined that visual identification information is to be determined by a method different from that of the normal determination operation and on the basis of the visual identification information for another display device having been identified through the checking operation.

Further, the visual information determination section may determine the visual identification information by using a portion of the unique information. Moreover, the visual information determination section may be configured to determine different visual identification information if a portion of the unique information used for determining the visual identification information is different.

Further, a MAC address may be used as the unique information, and the network may be a wireless network.

Further, the visual identification information may be provided with a color determined from among a plurality of colors on the basis of the unique information, the visual identification information may include a symbol determined from among a plurality of kinds on the basis of the unique information, and the visual identification information may include a figure determined from among a plurality of kinds on the basis of the unique information.

Further, the shared identification information may be an IEEE 802.11 SSID that includes the information regarding the visual identification information mode, and the SSID may also include code information for a name or an installation location of the display device. Moreover, the shared identification information may be a basic service-set identifier (BSSID) of IEEE 802.11 which includes the unique information.

Further, the present invention provides a terminal device that is connected to a plurality of display devices via a network and transmits image data on which images displayed by the display devices are based. The terminal device includes: a communication section for receiving, from a display device, shared identification information for sharing visual identification information for visually distinguishing the display device from the other display devices; a visual information obtaining section for obtaining, from the shared identification information, visual identification information that is the same as that of the display device having transmitted the shared identification information; a list display section for displaying a list of the visual identification information obtained for the plurality of display devices by the visual information obtaining section; and a connection processing section for establishing a connection between the terminal device and a display device that is selected by a user from among the plurality of display devices in a display image of the list display section.

Further, the present invention provides a display device connection support system including a terminal device that transmits image data and a plurality of display devices that receive the image data transmitted from the terminal device via a network and display received images generated from the image data. Each display device includes: a visual information determination section for determining visual identification information for visually distinguishing, in the terminal device, the display device from the other display devices, on the basis of preset unique information that is unique to the display device; a display section for displaying the visual identification information determined by the visual information determination section; and a communication section for transmitting to the terminal device shared identification information as information from which the terminal device can obtain the visual identification information determined by the visual information determination section. Before a connection to the terminal device is established, the display section displays the visual identification information and the communication section transmits the shared identification information to the terminal device. The terminal device includes: a communication section for receiving the shared identification information from the communication sections of the display devices; a visual information obtaining section for obtaining, from the shared identification information, visual identification information that is the same as that of a display device having transmitted the shared identification information; a list display section for displaying a list of the visual identification information obtained for the plurality of display devices by the visual information obtaining section; and a connection processing section for establishing a connection between the terminal device and a display device that is selected by a user from among the plurality of display devices in a display image of the list display section.

### BRIEF DESCRIPTION OF THE DRAWINGS

FIG. 1 is a configuration diagram of a display device according to a first embodiment as one mode of the present invention;

FIG. 2 is a configuration diagram of a terminal device according to the first embodiment as the one mode of the present invention;

FIG. 3 is a flowchart showing a procedure of display of visual identification information and transmission of an identification SSID in the display device according to the first embodiment as the one mode of the present invention;

FIG. 4 is a flowchart showing a procedure of establishing a connection between the terminal device and the display device according to the first embodiment as the one mode of the present invention;

FIG. 5 is a diagram illustrating projected images of display devices and a display screen of a terminal device in a display device connection support system according to the first embodiment as the one mode of the present invention;

FIG. 6 is a configuration diagram of a display device according to a second embodiment as one mode of the present invention;

FIG. 7 is a configuration diagram of a terminal device according to the second embodiment as the one mode of the present invention;

FIG. 8 is a flowchart showing a procedure of display of visual identification information in the display device according to the second embodiment as the one mode of the present invention; and

FIG. 9 is a flowchart showing a procedure of establishing a connection between the terminal device and the display device according to the second embodiment as the one mode of the present invention.

### DESCRIPTION OF THE PREFERRED EMBODIMENTS

### First Embodiment

Hereinafter, a first embodiment for practicing one mode of the present invention will be described with reference to the drawings. The first embodiment is a display device connection support system 1000 which includes a terminal device 200 and a plurality of display devices 100 which are connected to the terminal device 200 via a network (e.g., a wireless LAN network). It should be noted that the network via which the terminal device 200 and the plurality of display devices 100 are connected to each other may be a wired LAN network.

The terminal device 200 enables an operation (e.g., switching a display image, scrolling a display image, etc.) on a display image on a screen thereof to be performed in accordance with an input of a user. The terminal device 200 is, for example, a PC. Meanwhile, each display device 100 receives, from the terminal device 200, image data of a display image on the screen of the terminal device 200, and displays a received image generated from the image data. Each display device 100 is, for example, a network-adapted projector which is connectable to a network. Each display device 100 may be a network-adapted monitor which includes a screen for displaying a received image. It should be noted that, hereinafter, a state where a display device 100 which is caused to display a display image of the terminal device 200 is determined from among a plurality of reception devices is referred to a “connection established state”.

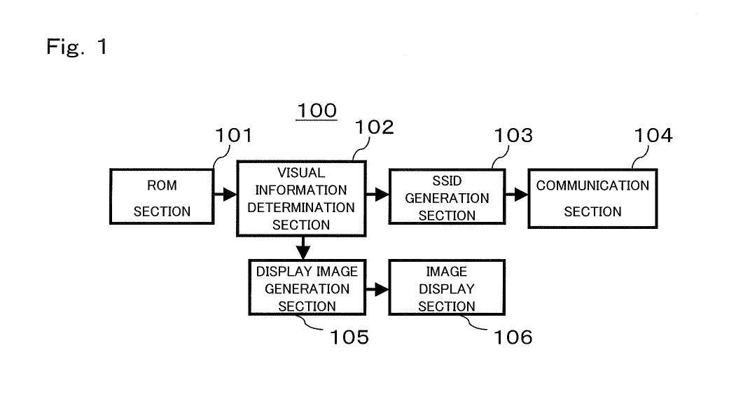

FIG. 1 is a configuration diagram of the display device 100 according to the first embodiment. The display device 100 includes a ROM section 101, a visual information determination section 102, an SSID generation section 103, a communication section 104, a display image generation section 105, and an image display section 106.

The ROM section 101 stores table information which defines code information for a color or a symbol so as to be associated with a MAC address or an arbitrary value as unique information (equipment unique information) of the display device 100. The code information is code information for later-described visual identification information. The visual information determination section 102 determines unique visual identification information on the basis of the unique information. The SSID generation section 103 generates an identification SSID (Service Set Identifier) on the basis of the visual identification information which is determined by the visual information determination section 102. The communication section 104 transmits the identification SSID generated by the SSID generation section 103 to an unspecified number of terminal devices 200, and performs connection communication (communication for displaying a received image) with the terminal device 200. The display image generation section 105 generates image data of the visual identification information which is determined by the visual information determination section 102, as image data which is to be displayed by the image display section 106. The image display section 106 displays an image of the visual identification information on the basis of the image data generated by the display image generation section 105.

Specifically, the ROM section 101 is a memory section on the display device 100 side. The ROM section 101 stores table information which defines code information obtained by coding the visual identification information with respect to the unique information.

Here, the unique information is, for example, information which is set for each display device 100 for distinguishing the display device 100 on the network from other network-connected equipment. As the unique information, address information representing an address of the display device 100 on the network is used. In the first embodiment, the MAC address is used. The unique information is a character string whose digit number is plural. As the unique information, other than the MAC address, an arbitrary value (e.g., a character string which is set by the user for each display device 100) may be used. It should be noted that the unique information is previously set before a connection to the terminal device 200 is established.

The visual information determination section 102 determines, on the basis of the unique information that is unique to the display device 100, visual identification information with respect to the unique information. The visual identification information is visual information for visually distinguishing the display device 100 from the other display devices 100, and is displayed by the later-described image display section 106. The visual identification information is visual information in a mode which can easily be identified by the user as compared to the case where the unique information is displayed as it is. When obtaining the unique information from the ROM section 101, the visual information determination section 102 determines visual identification information uniquely corresponding to the obtained unique information, from the table information stored in the ROM section 101.

The visual identification information is composed of a combination of main visual information such as a figure, a character, or a symbol, a color of the main visual information, and a background color of the main visual information, each of which is selected from among a plurality of patterns. When a figure is used as the main visual information, the figure may be a patterned figure. When a character is used as the main visual information, a character string whose digit number is less than that of the unique information (e.g., a character string having 1 to 4 digits) is used.

In the table information, a plurality of patterns of each of: first information obtained by coding the main visual information; second information obtained by coding the color of the main visual information; and third information obtained by coding the background color of the main visual information is set. For example, the visual information determination section 102 determines each of first information, second information, and third information from among the plurality of patterns by using the value of a specific digit of the unique information. The first information, the second information, and the third information are set, for example, by using different digits, respectively, of the unique information. Then, the visual information determination section 102 creates code information for the visual identification information by combining the first information, the second information, and the third information. For example, when the main visual information is a star, the first information becomes “Star”; when the color of the main visual information is white, the second information becomes “White”; when the background color of the main visual information is black (namely, a black background), the third information becomes “Black”; and the code information for the visual identification information which is obtained by these information becomes “Black_Star_White”. In this case, the third information, the first information, and the second information are arranged in order.

It should be noted that the visual information determination section 102 may determine visual identification information by using a portion of the digits of the unique information, or by using all the digits of the unique information. In addition, the visual information determination section 102 may be configured to determine different visual identification information if a portion of the unique information used for determining visual identification information is different.

It should be noted that the main visual information, the color of the main visual information, and the background color of the main visual information may not be used all together for the visual identification information, and the visual identification information may be composed of only the main visual information or may be composed of only the main visual information and the color (or the background color) of the main visual information. In addition, the visual identification information may be composed of only information for the color of a screen.

The SSID generation section 103 generates an identification SSID (Service Set IDentifier) on the basis of the visual identification information which is determined by the visual information determination section 102. The SSID generation section 103 is a shared information creation section which creates, as shared identification information, an identification SSID including the code information for the visual identification information. In the first embodiment, the identification SSID is a character string including the code information for the visual identification information as well as code information for a “set name” which is obtained by coding a name of the display device 100 which is set by the user. When the user sets a name of “Display2” for the display device 100, the identification SSID becomes “Display2_Black_Star_White”. It should be noted that instead of or in addition to the code information for the set name, code information (e.g., “Room1”) of the installation location of the display device 100 may be used.

The communication section 104 performs communication with the terminal device 200 and the other display devices 100 which are connected to the network in common with the display device 100. The communication section 104 transmits the identification SSID generated by the SSID generation section 103 to an unspecified number of terminal devices 200, and receives image data from the terminal device 200 in the connection established state.

The display image generation section 105 generates image data of the visual identification information from the code information for the visual identification information which is determined by the visual information determination section 102. The image display section 106 receives the image data of the visual identification information from the display image generation section 105 and displays the visual identification information. For example, the image display section 106 projects the visual identification information to a screen to display the visual identification information thereon. The display image generation section 105 and the image display section 106 correspond to a display section for displaying the visual identification information which is determined by the visual information determination section 102. It should be noted that the image display section 106 may display the visual identification information on a location different from a location where a received image is displayed. For example, the visual identification information may be displayed on a liquid crystal screen provided on an outer surface of the display device 100.

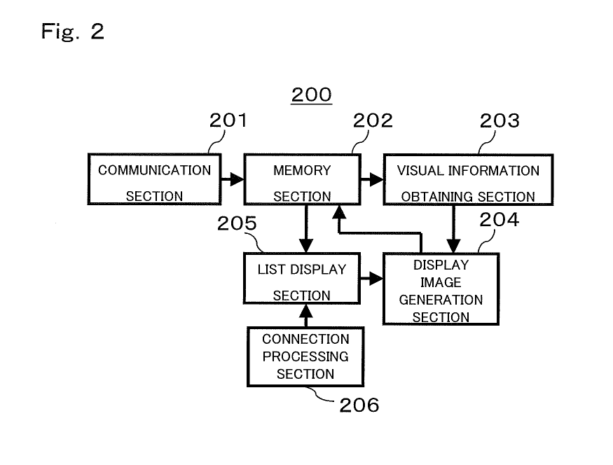

FIG. 2 is a configuration diagram of the terminal device 200 according to the first embodiment. The terminal device 200 includes a communication section 201, a memory section 202, a visual information obtaining section 203, a display image generation section 204, a list display section 205, and a connection processing section 206.

The communication section 201 receives the identification SSID transmitted from the display device 100 and performs connection communication with the display device 100. The memory section 202 stores the identification SSID received by the communication section 201, image data generated by the display image generation section 204, and the like. The visual information obtaining section 203 extracts code information for visual identification information from the identification SSID stored in the memory section 202. The display image generation section 204 generates image data of the visual identification information which is to be displayed by the list display section 205, on the basis of the code information for the visual identification information which is extracted by the visual information obtaining section 203. The list display section 205 displays a list of the visual identification information for a plurality of display devices 100 on the basis of the image data generated for each display device 100. The connection processing section 206 selects an item representing a desired display device 100 from the visual identification information in the list displayed by the list display section 205, and performs a process of connecting to the selected display device 100.

Specifically, the communication section 201 performs communication with the display device 100 which is connected to the network in common with the terminal device 200. The communication section 201 receives the identification SSID transmitted from the communication section 104 of the display device 100 and transmits, to the display device 100, image data of a display image displayed on a monitor of the terminal device 200 in the connection established state.

The memory section 202 stores the identification SSID received by the communication section 201, the image data generated by the display image generation section 204, and the like. When the communication section 201 receives identification SSIDs from a plurality of display devices 100, the identification SSIDs are stored for the display devices 100, respectively, in the memory section 202.

The visual information obtaining section 203 extracts the code information for visual identification information from the identification SSID stored in the memory section 202. When the identification SSIDs of a plurality of display devices 100 are stored in the memory section 202, the visual information obtaining section 203 extracts the code information for visual identification information from the identification SSID of each display device 100.

The display image generation section 204 generates image data of the visual identification information which is to be displayed by the list display section 205, on the basis of the code information for the visual identification information which is extracted by the visual information obtaining section 203. The image data is created for each display device 100 which has transmitted the identification SSID, and is stored in the memory section 202.

The list display section 205 displays a list of the visual identification information for all the display devices 100 by using the image data which is generated for each display device 100 by the display image generation section 204. The list display section 205 obtains, from the memory section 202, the image data of the visual identification information for all the display devices 100 which have transmitted the identification SSIDs, and displays all the obtained visual identification information.

The connection processing section 206 includes an input section (e.g., a keyboard) in order for the user to select a desired display device 100 which is desired to display a display image of the terminal device 200 while looking at the visual identification information for the plurality of display devices 100 in the list displayed by the list display section 205. The connection processing section 206 further includes a connection section which, when the user selects a desired display device 100, performs a process of establishing a connection between the selected display device 100 and the terminal device 200.

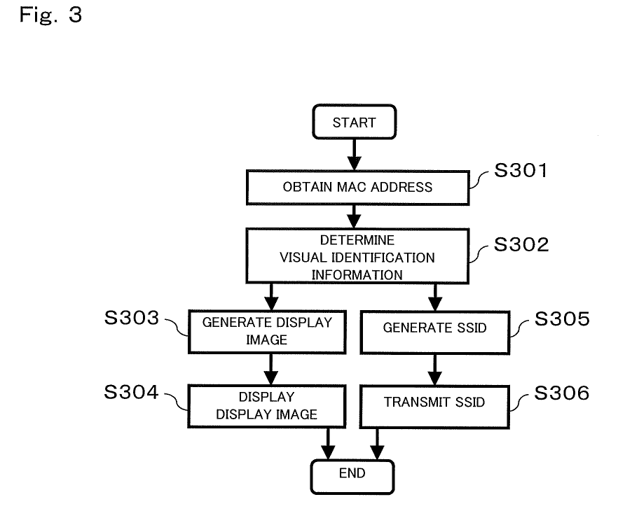

FIG. 3 is a flowchart showing a procedure of display of the visual identification information and transmission of the identification SSID in the display device 100 according to the first embodiment. In the display device 100, for example, when the display device 100 is turned on by the user, the MAC address which is the unique information that is unique to the display device 100 is obtained from the ROM section 101 at step S301. Next, at step S302, visual identification information for distinguishing the display device 100 from other display devices is determined by using the table information stored in the ROM section 101 and on the basis of the MAC address obtained at step S301. After step S302, processes from step S303 to step S304 and processes from step S305 to step S306 are independently performed.

Here, the code information for the visual identification information is, for example, information obtained by coding information for a black star symbol on a white background. The kinds of colors and symbols are limited. Thus, in order to determine visual identification information which does not overlap that of other display devices, the visual identification information is desirably composed of a combination of a color and a symbol, but may be composed of only a color or a symbol. As colors to be used, colors which have a small number of gradation levels and can easily be identified are desirably used in order not to depend on the performance and the usage environment of the display device 100. However, when it is difficult to use such colors, patterns may be used. Regarding symbols as well, symbols having easily-identifiable shapes are used.

When the numbers of the kinds of colors and symbols are small and many other display devices are present near the display device 100 executing step S302 (in a range in which the display device 100 can perform communication), there is the possibility that the visual identification information will overlap that of another display device. In this case, the visual information determination section 102 performs a checking operation of checking the visual identification information for the other display devices in the range in which wireless communication is possible, by using the communication section 104. The visual information determination section 102 determines visual identification information for the display device 100 on the basis of the visual identification information for the other display devices which has been identified through the checking operation. In the checking operation, the visual information determination section 102 obtains, from the other display devices with which the display device 100 can communicate, checking information including at least either one of information corresponding to the unique information or information regarding the mode of the visual identification information for the other display devices, and identifies the visual identification information for the other display devices from the checking information. The checking information may be the identification SSID or unique information such as the MAC address.

For example, the visual information determination section 102 may determine visual identification information for the display device 100 such that the visual identification information for the display device 100 does not overlap the visual identification information for the other display devices which has been identified through the checking operation. In addition, the visual information determination section 102 may determine visual identification information for the display device 100 such that the visual identification information for the display device 100 does not belong to a predetermined range of similarity to the visual identification information for the other display devices which has been identified through the checking operation. For example, when the color of the visual identification information for another display device is red and the color of the visual identification information for the display device 100 which is determined on the basis of the table information is yellow, for example, the color of visual identification information is determined to be blue. In the range of similarity, combinations of figures, symbols, and colors which are easy for the user to erroneously recognize are set.

In this case, the visual information determination section 102 may be configured to be enabled to perform: a normal determination operation of determining visual identification information on the basis of the unique information; and a provisional determination operation of determining visual identification information by a method different from that of the normal determination operation when it is determined that visual identification information is to be determined by a method different from that of the normal determination operation and on the basis of the visual identification information for the other display devices which has been identified through the checking operation. For example, a plurality of pieces of table information based on which visual identification information different from each other is determined from the same unique information may be stored in the ROM section 101, and the table information used in the normal determination operation may be different from that in the provisional determination operation. In addition, digits of the unique information which are used for determining visual identification information in the normal determination operation may be different from those in the provisional determination operation.

The method for determining visual identification information can be realized as a method in which code information for a color or a symbol corresponding to the remaining values of the MAC address values is obtained from the table information which is stored in the ROM section 101 and defines code information (code information for visual identification information) of a color or a symbol corresponding to an arbitrary value, as described above.

At step S303, image data of the visual identification information which is to be displayed on the entirety or a portion of the screen of the display device 100, or in some other on-screen display format is generated by using the code information for the visual identification information obtained at step S302. At step S304, the visual identification information is actually displayed by using the image data generated at step S303.

At step S305, an identification SSID which is to be transmitted to an unspecified number of terminal devices 200 is generated on the basis of the code information for the visual identification information. When it is desired to display a black symbol on a white background, the identification SSID becomes a character string such as “Display2_Black_Star_White” which is a combination of the visual identification information and an identifier (e.g., a set name) of the display device 100 corresponding to the visual identification information. At step S306, the identification SSID generated at step S305 is transmitted from the communication section 104.

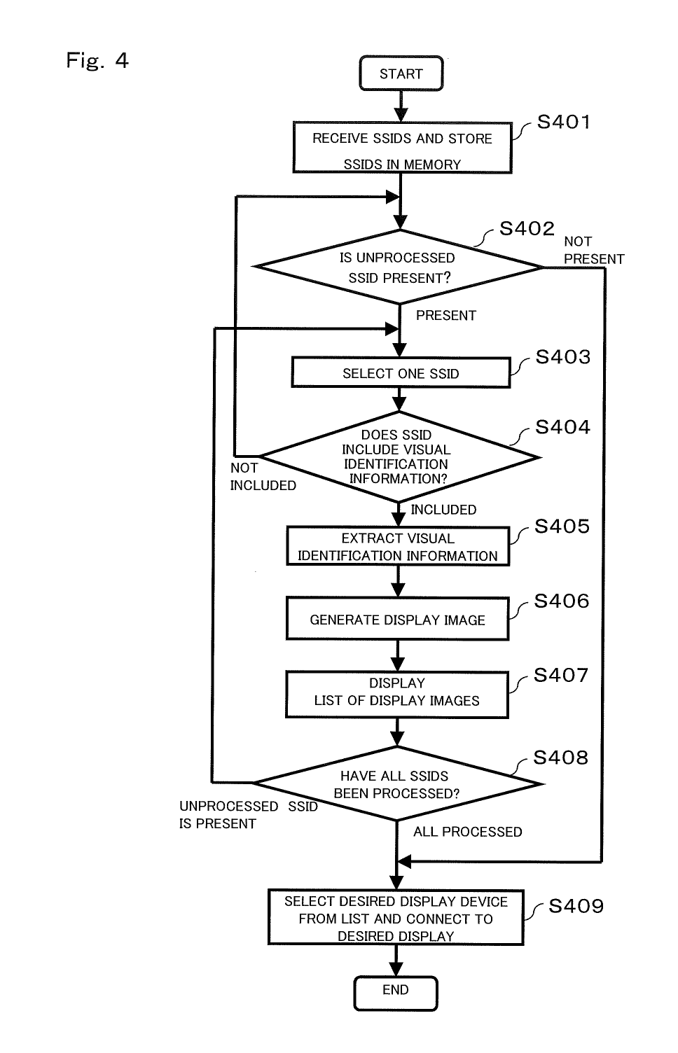

FIG. 4 is a flowchart showing a procedure of establishing a connection between the terminal device 200 and the display device 100 according to the first embodiment. In the terminal device 200 such as a PC, dedicated application software has been activated, and the following procedure is performed.

First, at step S401, identification SSIDs transmitted from a plurality of display devices 100 are received by the communication section 201 and stored (saved) in the memory section 202. At step S401, when the communication section 201 also receives SSIDs other than the identification SSIDs, the SSIDs are stored in the memory section 202.

At step S402, it is determined whether any unprocessed SSID which has not been selected at later-described step S403 is present. At step S402, when it is determined that any unprocessed SSID is present, one SSID is selected from among the SSIDs stored in the memory section 202 at step S403. In the first embodiment, the example where the SSIDs received by the communication section 201 are stored in the memory section 202 is shown. However, a method may be employed in which each time the communication section 201 receives an SSID, a process on the SSID (e.g., processes from steps S403 to S407) is performed.

At step S404, it is determined whether the SSID selected at step S403 includes code information for visual identification information. In other words, it is determined whether the selected SSID is an identification SSID. When it is determined at step S404 that visual identification information is included, the code information for the visual identification information is extracted from the identification SSID at step S405. In the first embodiment, code information for a set name is also extracted. On the other hand, when it is determined at step S404 that visual identification information is not included, the processing returns to step S402 and it is determined whether any other unprocessed SSID is present. At step S402, when any unprocessed SSID is present, the processing proceeds to step S403, and when no unprocessed SSID is present, the processing proceeds to step S409.

At step S406, image data (a display image) of the visual identification information is generated from the code information for the visual identification information which is extracted at step S405. Subsequently, at step S407, an image of the visual identification information which is generated from the image data generated at step S406 is displayed in a list. It should be noted that when the list display section 205 has already displayed the visual identification information for other display devices, the image of the visual identification information which is generated from the image data generated at step S406 is added to the list. In addition, when the list display section 205 has not displayed the visual identification information for any other display devices, the single image of the visual identification information which is generated from only the image data generated at step S406 is displayed. At step S408, it is determined whether the process at step S403 has been performed on all the SSIDs. When any other unprocessed SSID is present, the processing returns to step S403.

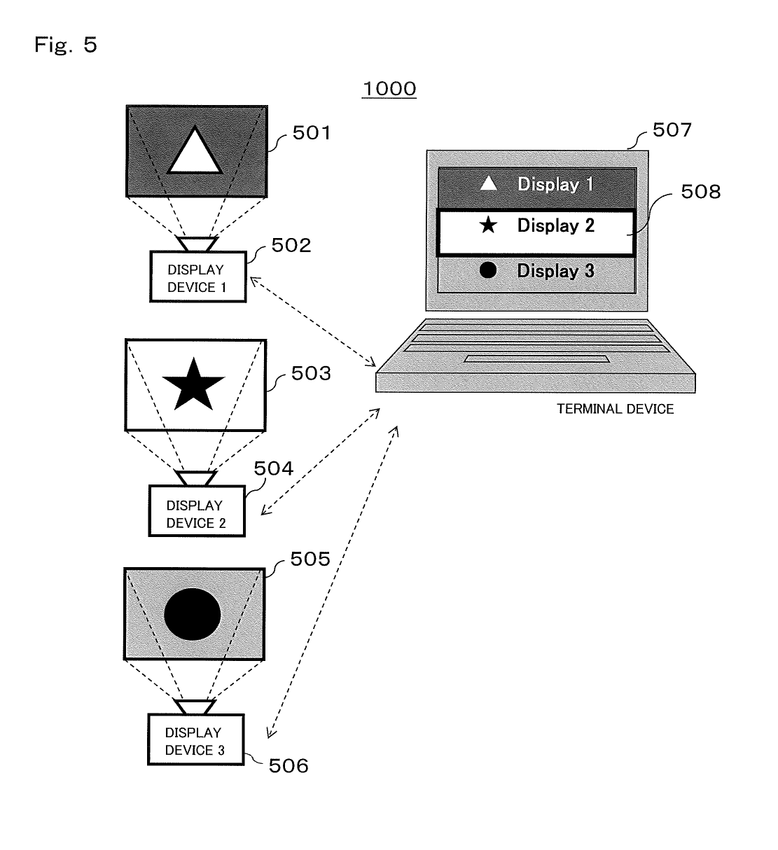

FIG. 5 is a diagram illustrating display screens of the display devices 100 and the terminal device 200. As shown in FIG. 5, three display devices 502, 504, and 506 display images 501, 503, and 505 of visual identification information, respectively. Meanwhile, as shown in FIG. 5, a terminal device 507 displays a list of the visual identification information. In the first embodiment, the name of each display device is displayed so as to be associated with the visual identification information. For the name of the display device, image data is created on the basis of code information for a set name. If the user selects an item 508 in which the visual identification information (a black star symbol on a white background) corresponding to the display device 504 is present from the list of the images of the visual identification information, which is displayed on the terminal device 507, at step S409 when the user desires connection to the display device 504, a connection process of establishing a connection between the terminal device 507 and the display device 504 is performed. After completion of the connection process, image data of the terminal device 507 is transmitted to the display device 504, and a received image generated from the image data is displayed by the display device 504. It should be noted that the case where all the display devices 502, 504, and 506 are turned on is shown in FIG. 5, but when a display device which is turned off is present, visual identification information is not displayed by this display device.

### Second Embodiment

Next, a second embodiment as one mode of the present invention will be described.

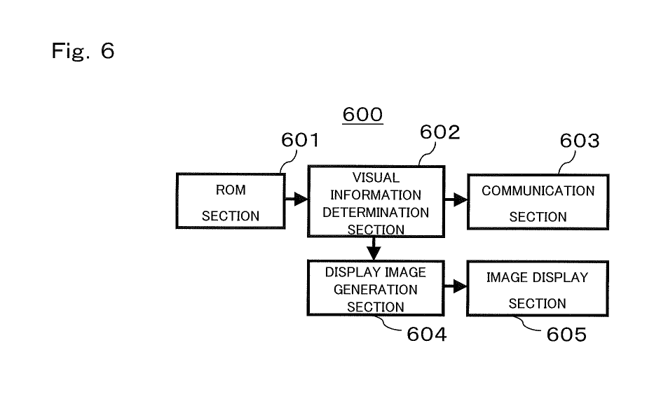

FIG. 6 is a configuration diagram of a display device 600 according to the second embodiment. The display device 600 includes a ROM section 601, a visual information determination section 602, a communication section 603, a display image generation section 604, and an image display section 605.

In FIG. 6, the ROM section 601 stores table information which defines code information (code information for visual identification information) of a color or a symbol so as to be associated with a MAC address or an arbitrary value which is unique information (equipment unique information) of the display device 600. The visual information determination section 602 determines unique visual identification information on the basis of the unique information. The communication section 603 transmits a BSSID to an unspecified number of terminal devices 700, and performs connection communication with the terminal devices 700. The display image generation section 604 generates image data of the visual identification information which is determined by the visual information determination section 602, as image data which is to be displayed by the image display section 605. The image display section 605 displays an image of the visual identification information on the basis of the image data generated by the display image generation section 604. In the second embodiment, as shared identification information, the BSSID including the unique information is used, and an identification SSID is not used.

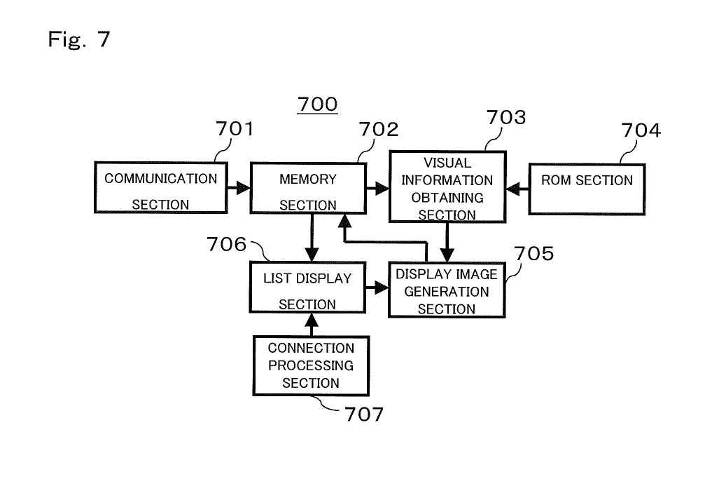

FIG. 7 is a configuration diagram of the terminal device 700 according to the second embodiment. The terminal device 700 includes a communication section 701, a memory section 702, a visual information obtaining section 703, a ROM section 704, a display image generation section 705, a list display section 706, and a connection processing section 707.

The communication section 701 receives the BSSID transmitted from the display device 600, and performs connection communication with the display device 600. The memory section 702 stores the BSSID received by the communication section 701, and image data generated by the display image generation section 705, and the like. The visual information obtaining section 703 obtains code information for visual identification information by using table information stored in the ROM section 704 and on the basis of the unique information that is unique to the BSSID stored in the memory section 702. The ROM section 704 stores the table information which defines code information (code information for visual identification information) of a color or a symbol so as to be associated with an arbitrary value. The ROM section 704 stores table information which is the same as that in the ROM section 601 of the display device 600. The visual information obtaining section 703 obtains code information for visual identification information by using unique information and table information which are the same as those in the display device 600, and thus the obtained code information for the visual identification information is the same as that in the display device 600. The display image generation section 705 generates image data of the visual identification information which is to be displayed by the list display section 706, on the basis of the code information for the visual identification information which is obtained by visual information obtaining section 703. The list display section 706 displays a list of a display image of the image data generated for each display device 600. The connection processing section 707 selects an item representing a desired display device 600 from the display images in the list displayed by the list display section 706, and performs a process of connecting to the selected display device 600.

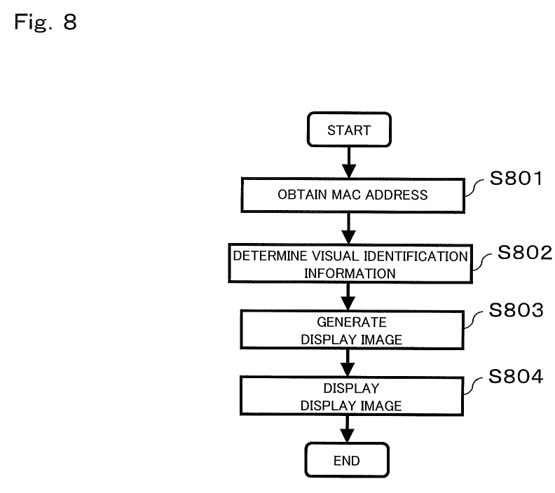

FIG. 8 is a flowchart showing a procedure of display of the visual identification information in the display device 600 according to the second embodiment. In the display device 600, for example, when the display device 600 is turned on by the user, the MAC address which is the unique information that is unique to the display device 600 is obtained from the ROM section 601 at step S801. Next, at step S802, code information for visual identification information for distinguishing the display device 600 from other display devices is determined by using the table information stored in the ROM section 601 and on the basis of the MAC address obtained at step S801. The method for determining visual identification information is the same as that in the first embodiment. At step S803, image data of the visual identification information which is to be displayed on the entirety or a portion of the screen of the display device 600, or in some other on-screen display format is generated by using the code information for the visual identification information which is determined at step S802. At step S804, the visual identification information is actually displayed by using the image data generated at step S803.

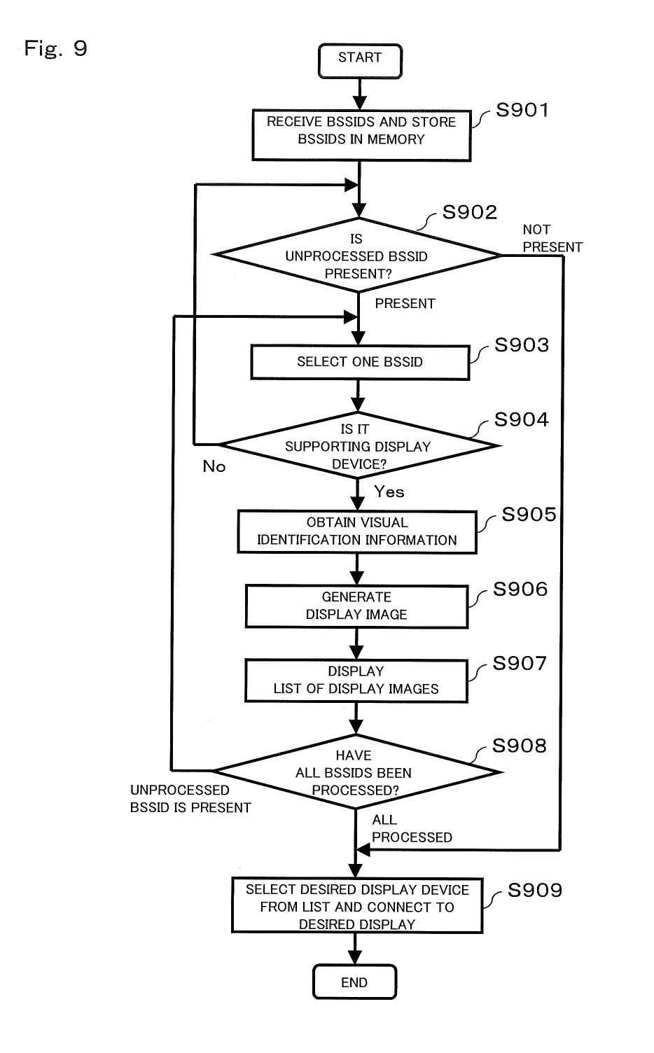

FIG. 9 is a flowchart showing a procedure of establishing a connection between the terminal device 700 and the display device 600 according to the second embodiment. In the terminal device 700 such as a PC, dedicated application software has been activated, and the following procedure is performed.

First, at step S901, BSSIDs transmitted from a plurality of display devices 600 are received by the communication section 701 and stored (saved) in the memory section 702. Each BSSID has the same values as those of the MAC address of the display device 600 (equipment) which has transmitted this BBSID. At step S902, it is determined whether any unprocessed BSSID which has not been selected at later-described step S903 is present. When it is determined at step S902 that any unprocessed BSSID is present, the processing proceeds to step S903. At step S903, one BSSID is selected from among the BSSIDs stored in the memory section 702. In the second embodiment, the example where the received BSSIDs are stored in the memory section 702 is shown. However, a method may be employed in which each time the communication section 701 receives a BSSID, a process on the BSSID (e.g., processes from step S903 to S907) is performed.

At step S904, it is determined whether the BSSID selected at step S903 is the BSSID of a display device 600 that supports the display of the visual identification information (which is a display device having the same table information as that in the terminal device 700 and, hereinafter, is referred to as “supporting display device”). As a method for determining whether it is the supporting display device 600, a method in which it is determined from the vendor ID or the model ID of the BSSID or a method in which a sign (e.g., a name) indicating that it is the supporting display device 600 is provided to an SSID transmitted together with the BSSID is used. When it is determined at step S904 that it is the supporting display device 600, the code information for the visual identification information for distinguishing the display device 600 from other display devices is obtained at step S905 by using the table information stored in the ROM section 704 and on the basis of the unique information (MAC address) of the selected BSSID. On the other hand, when it is determined at step S904 that it is not the supporting display device 600, the processing returns to step S902 and it is determined whether any other unprocessed BSSID is present. The method for obtaining visual identification information is the same as the method for determining visual identification information from unique information as described in the first embodiment. At step S902, when any unprocessed BSSID is present, the processing proceeds to step S903, and when no unprocessed BSSID is present, the processing proceeds to step S909.

At step S906, image data (a display image) of the visual identification information is generated from the code information for the visual identification information obtained at step S905. Subsequently, at step S907, an image of the visual identification information which is generated from the image data generated at step S906 is displayed in a list. At step S908, it is determined whether the process at step S903 has been performed on all the BSSIDs. When any other unprocessed BSSID is present, the processing returns to step S903.

For example, in FIG. 5, the three display devices 502, 504, and 506 display the displays images 501, 503, and 505, respectively. Meanwhile, as shown in FIG. 5, the terminal device 507 displays the list of the visual identification information. If the user selects the item 508 in which the visual identification information (the black star symbol on the white background) corresponding to the display device 504 is present from the list of the images of the visual identification information, which is displayed on the terminal device 507, at step S909 when the user desires connection to the display device 504, a connection process of establishing a connection between the terminal device 507 and the display device 504 is performed. After completion of the connection process, image data of the terminal device 507 is transmitted to the display device 504, and a received image generated from the image data is displayed by the display device 504.

### Other Embodiments

In the embodiments described above, the processes of the flowcharts for performing generation and display of visual identification information in the display devices 100 and 600 may not be triggered by start-up of the display devices 100 and 600 but may instead be triggered by reception of an instruction to start display of a received image from the user when the display devices 100 and 600 are in a standby state. In addition, the processes may be triggered by a signal transmitted by the terminal device 200.

While the invention has been described in detail, the foregoing description is in all aspects illustrative and not restrictive. It will be understood that numerous other modifications and variations can be devised without departing from the scope of the invention.

What is claimed is:

1. A display device connected to a network, and receiving image data transmitted from a terminal device, and displaying received images generated from the image data, the display device comprising:
a visual information determination section for determining visual identification information for visually distinguishing, in the terminal device, said display device from other display devices, on the basis of preset unique information that is unique to said display device;
a display section for displaying the visual identification information determined by the visual information determination section; and
a communication section for transmitting to the terminal device shared identification information, as information from which the terminal device can obtain the visual identification information determined by the visual information determination section; wherein
before a connection to the terminal device is established, the display section displays the visual identification information and the communication section transmits to the terminal device the shared identification information.

2. The display device according to claim 1, wherein the shared identification information includes at least one of either the unique information or information regarding a mode for the visual identification information.

3. The display device according to claim 1, wherein the visual information determination section performs a checking operation of checking visual identification information for another display device with which said display device can communicate, and determines the visual identification information for said display device on the basis of the visual identification information for another display device having been identified through the checking operation.

4. The display device according to claim 3, wherein the visual information determination section determines the visual identification information for said display device such that the visual identification information for said display device does not overlap the visual identification information for another display device having been identified through the checking operation.

5. The display device according to claim 3, wherein the visual information determination section determines the visual identification information for said display device such that the visual identification information for said display device does not belong to a predetermined range of similarity to the visual identification information for another display device having been identified through the checking operation.

6. The display device according to claim 3, wherein, in the checking operation, the visual information determination section obtains, from another display device with which the display device can communicate, information including at least one of either information corresponding to the unique information or information regarding a mode for the visual identification information for the other display device, and identifies the visual identification information for the other display device from the obtained information.

7. The display device according to claim 3, wherein the visual information determination section is enabled to perform: a normal determination operation of determining the visual identification information on the basis of the unique information; and a provisional determination operation of determining the visual identification information by a method different from that of the normal determination operation, when it is determined that visual identification information is to be determined by a method different from that of the normal determination operation and on the basis of the visual identification information for another display device having been identified through the checking operation.

8. The display device according to claim 1, wherein the visual information determination section determines the visual identification information by using a portion of the unique information.

9. The display device according to claim 1, wherein the visual information determination section is configured to determine different visual identification information if a portion of the unique information used for determining the visual identification information is different.

10. The display device according to claim 1, wherein a MAC address is used as the unique information.

11. The display device according to claim 1, wherein the network is a wireless network.

12. The display device according to claim 1, wherein the visual identification information is provided with a color determined from among a plurality of colors on the basis of the unique information.

13. The display device according to claim 1, wherein the visual identification information includes a symbol determined from among a plurality of kinds on the basis of the unique information.

14. The display device according to claim 1, wherein the visual identification information includes a figure determined from among a plurality of kinds on the basis of the unique information.

15. The display device according to claim 2, wherein the shared identification information is an IEEE 802.11 SSID that includes the information regarding the visual identification information mode.

16. The display device according to claim 15, wherein the SSID further includes code information for a name or an installation location of the display device.

17. The display device according to claim 2, wherein the shared identification information is an IEEE 802.11 BSSID that includes the unique information.

18. A terminal device connected to a plurality of display devices via a network, and transmitting image data on which images displayed by the display devices are based, the terminal device comprising:
a communication section for receiving, from a display device, shared identification information for sharing visual identification information for visually distinguishing said display device from the other display devices;
a visual information obtaining section for obtaining, from the shared identification information, visual identification information that is the same as that of the display device having transmitted the shared identification information;
a list display section for displaying a list of visual identification information obtained for the plurality of display devices by the visual information obtaining section; and
a connection processing section for establishing a connection between the terminal device and a display device that is selected by a user from among the plurality of display devices in a display image of the list display section.

19. A display device connection support system including a terminal device that transmits image data and a plurality of display devices that receive the image data transmitted from the terminal device via a network and display received images generated from the image data, wherein:
each display device includes
a visual information determination section for determining visual identification information for visually distinguishing, in the terminal device, said display device from the other display devices, on the basis of preset unique information that is unique to said display device,
a display section for displaying the visual identification information determined by the visual information determination section, and
a communication section for transmitting to the terminal device shared identification information, as information from which the terminal device can obtain the visual identification information determined by the visual information determination section, wherein
before a connection to the terminal device is established, the display section displays the visual identification information and the communication section transmits the shared identification information to the terminal device; and
the terminal device includes
a communication section for receiving the shared identification information from the communication sections of the display devices,
a visual information obtaining section for obtaining, from the shared identification information, visual identification information that is the same as that of a display device having transmitted the shared identification information,
a list display section for displaying a list of the visual identification information obtained for the plurality of display devices by the visual information obtaining section, and
a connection processing section for establishing a connection between the terminal device and a display device that is selected by a user from among the plurality of display devices in a display image of the list display section.
